(19) United States
(12) Patent Application Publication
(10) Pub. No.: US 2016/0154487 A1
(43) Pub. Date: Jun. 2, 2016

(54) ELECTRONIC APPARATUS, METHOD AND STORAGE MEDIUM

(71) Applicant: Kabushiki Kaisha Toshiba, Tokyo (JP)

(72) Inventor: Yoji Nagao, Ome Tokyo (JP)

(21) Appl. No.: 14/724,580

(22) Filed: May 28, 2015

Related U.S. Application Data
(60) Provisional application No. 62/086,413, filed on Dec. 2, 2014.

(51) Int. Cl. G06F 3/0354

(52) U.S. Cl. CPC G06F 3/03547

(57) ABSTRACT

According to one embodiment, an electronic apparatus configured to connect to at least one external monitor and including a display and a processing circuit is provided. The processing circuit is configured to detect an operation which indicates a number allocated for the external monitor and switch an operative screen from a screen of the display to a screen of the external monitor for which the number indicated by the detected operation is allocated.

### CROSS-REFERENCE TO RELATED APPLICATIONS

This application claims the benefit of U.S. Provisional Application No. 62/086,413, filed Dec. 2, 2014, the entire contents of which are incorporated herein by reference.

### FIELD

Embodiments described herein relate generally to an electronic apparatus, a method and a storage medium.

### BACKGROUND

In recent years, various types of electronic devices such as a notebook computer and a tablet computer have been developed.

Some of the electronic devices can perform expansion desktop display. In expansion desktop display, the screen can be enlarged by using the display of the electronic device and at least one external monitor connected to the electronic device.

Here, the electronic apparatus used in expansion desktop display is assumed to be a notebook computer including a touchpad. In the notebook computer, the user can operate the pointer (mouse pointer) on the screen by sliding a finger on the touchpad.

In this case, to perform an operation relative to an object displayed on the screen of the external monitor connected to the notebook computer, for example, the user needs to move the pointer displayed on the display screen of the notebook computer onto the screen displayed on the external monitor. To move the pointer, the user has to repeatedly slide his/her finger on the touchpad. This operation is troublesome for the user. When a plurality of external monitors are connected to the notebook computer, the distance of moving the pointer is greater. Thus, the operation is more complicated.

When expansion desktop display is performed in an electronic device which is a tablet computer including a touchpanel, the user can perform an operation relative to an object displayed on the display screen of the tablet computer by using the touchpanel. However, the user cannot perform an operation relative to an object displayed on the screen of the external monitor.

In consideration of the above factors, in expansion desktop display, a mechanism which allows the user to easily perform an operation relative to the screen of the external monitor (specifically, an object displayed on the screen) is desired.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view showing an example of external appearance of an electronic apparatus according to a first embodiment.

FIG. 2 shows an example of a system configuration of the electronic apparatus.

FIG. 3 is a block diagram showing an example of a function structure of the electronic apparatus.

FIG. 4 shows an example of a data structure of a storage.

FIG. 5 is a flowchart showing an example of a procedure of a number allocation process.

FIG. 6 is a flowchart showing an example of a procedure of a screen switching process.

FIG. 7 is shown for explaining a pointer which is moved in a switching operation.

FIG. 8 is shown for explaining a case where the electronic apparatus is realized as a tablet computer.

FIG. 9 is a perspective view showing an example of external appearance of an electronic apparatus according to a second embodiment.

FIG. 10 shows an example of a system configuration of the electronic apparatus.

FIG. 11 is a flowchart showing an example of a procedure of a screen switching process.

FIG. 12 is shown for explaining a pointer displayed in a switching operation.

FIG. 13 is shown for explaining a case where an operation relative to a touchpanel is performed with one finger.

### DETAILED DESCRIPTION

Various embodiments will be described hereinafter with reference to the accompanying drawings.

In general, according to one embodiment, an electronic apparatus configured to connect to at least one external monitor and including a display and a processing circuit is provided. The processing circuit is configured to detect an operation which indicates a number allocated for the external monitor and switch an operative screen from a screen of the display to a screen of the external monitor for which the number indicated by the detected operation is allocated.

### First Embodiment

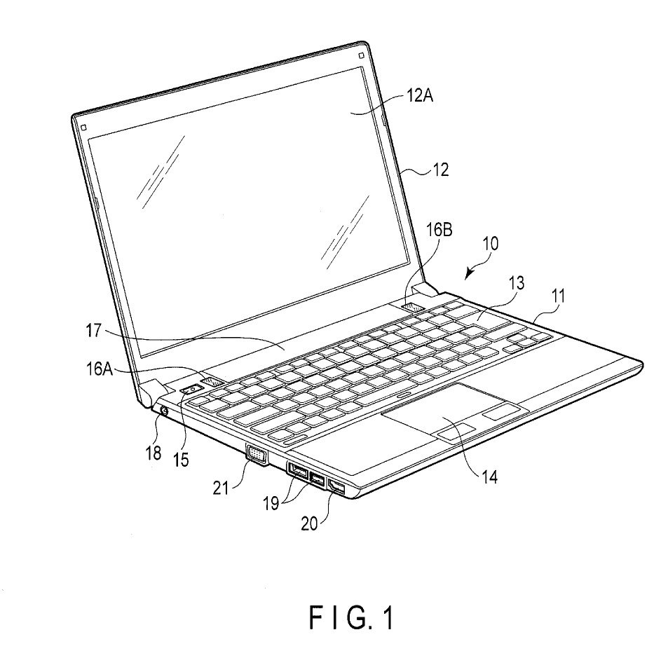

This specification explains a first embodiment. FIG. 1 is a perspective view showing the external appearance of an electronic apparatus according to the present embodiment. The electronic apparatus can be realized as, for example, a notebook computer or a tablet computer for the user. FIG. 1 shows an example in which the electronic apparatus is realized as a notebook computer. In the explanation below, this specification assumes that the electronic apparatus of the present embodiment is realized as a notebook computer.

As shown in FIG. 1, an electronic apparatus 10 includes an electronic apparatus main body (computer main body) 11 and a display unit 12. A display such as a liquid crystal display (LCD) 12A is incorporated into the display unit 12. When the electronic apparatus 10 is booted, the screen of the LCD 12A (display) displays various objects (for example, an icon, a window and a dialogue), a pointer (mouse pointer) and the like. The user can perform an operation relative to various objects by operating the pointer displayed on the screen as described below.

The display unit 12 is attached to the electronic apparatus main body 11 such that the display unit 12 is rotatable between the open position where the upper surface of the electronic apparatus main body 11 is exposed and the closed position where the upper surface of the electronic apparatus main body 11 is covered by the display unit 12. The electronic apparatus main body 11 includes a housing having the shape of a thin box. On the upper surface of the electronic apparatus main body 11, for example, a keyboard 13, a touchpad 14, a power switch 15 and speakers 16A and 16B are provided.

The keyboard 13 is an input device for allowing the user to input, for example, characters in the electronic apparatus 10. The touchpad 14 is configured to detect contact of a user's finger. The touchpad 14 is a pointing device configured to operate the pointer in accordance with, for example, a slide operation performed by the user with a finger. The power switch 15 is a switch for turning the electronic apparatus 10 on or off. The power switch 15 has the shape of, for example, a button. The speakers 16A and 16B are output devices for outputting music and sound, etc.

The electronic apparatus 10 is configured to receive power from a battery 17. In the present embodiment, the battery 17 is, for example, embedded in the electronic apparatus 10.

In the electronic apparatus main body 11, a power connector (DC power input terminal) 18 is provided. The power connector 18 is provided on a side surface of the electronic apparatus main body 11; for example, on the left side surface. An external power device is removably connected to the power connector 18. For the external power device, an AC adaptor can be employed. The AC adaptor is a power device which converts commercial power (AC power) to DC power.

The electronic apparatus 10 is driven by power supplied from the battery 17 or power supplied from an external power device. When no external power device is connected to the power connector 18 of the electronic apparatus 10, the electronic apparatus 10 is driven by power supplied from the battery 17. When an external power device is connected to the power connector 18 of the electronic apparatus 10, the electronic apparatus 10 is driven by power supplied from the external power device. The power supplied from the external power device is also used for charging the battery 17.

For example, a plurality of USB ports 19, a High-Definition Multimedia Interface (HDMI) (registered trademark) output terminal 20 and an RGB port 21 are provided in the electronic apparatus main body 11.

The electronic apparatus 10 of the present embodiment is configured to perform expansion desktop display. In the present embodiment, when an external monitor (external device) is connected to the electronic apparatus 10 via, for example, the HDMI output terminal 20 provided in the electronic apparatus 10, the screen can be enlarged by using the display (LCD 12A) of the electronic apparatus 10 and the external monitor. In this case, different screens are displayed on the display of the electronic apparatus 10 and the external monitor. A plurality of external monitors are connectable to the electronic apparatus 10.

When expansion desktop display is performed, the display of the electronic apparatus 10 and the screen of the external monitor are used as an enlarged screen. Thus, the pointer is displayed on only one of the display of the electronic apparatus 10 and the screen of the external monitor.

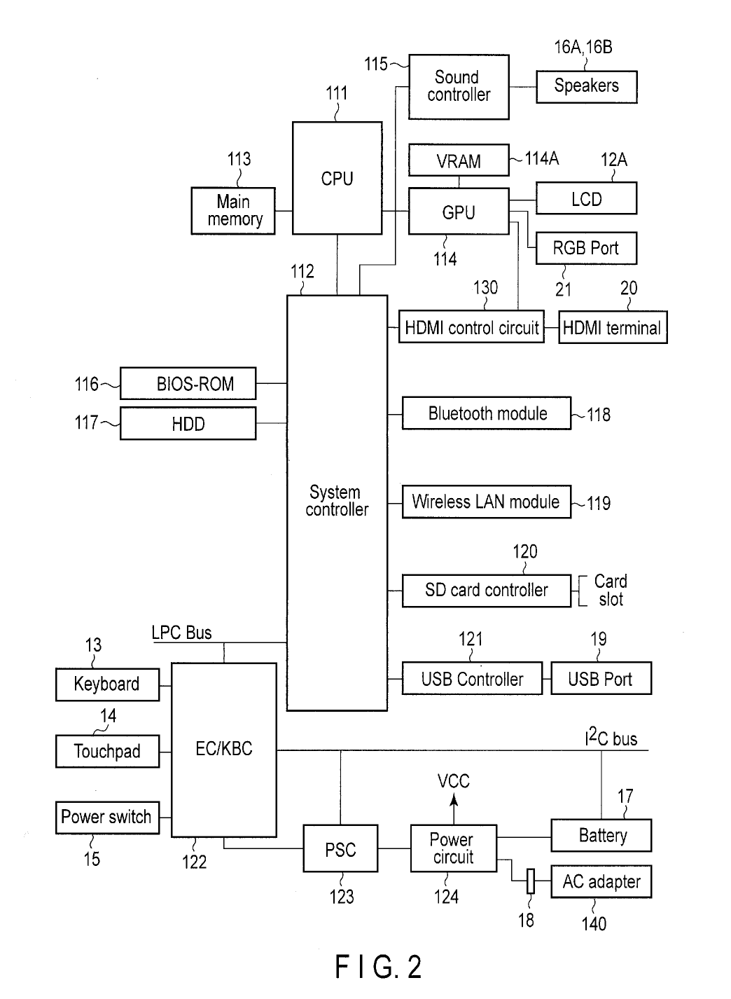

FIG. 2 shows a system configuration of the electronic apparatus 10 of FIG. 1. The electronic apparatus 10 includes, for example, a CPU 111, a system controller 112, a main memory 113, a graphics processing unit (GPU) 114, a sound controller 115, a BIOS-ROM 116, a hard disk drive (HDD) 117, a Bluetooth (registered trademark) module 118, a wireless LAN module 119, an SD card controller 120, a USB controller 121, an embedded controller/keyboard controller IC (EC/KBC) 122, a power source controller (PSC) 123 and a power circuit 124.

The CPU 111 is a processor configured to control the operation of each component of the electronic apparatus 10. The processor includes at least one processing circuit. The CPU 111 executes software loaded from the HDD 117 into the main memory 113 such as an operating system (OS), various utility programs and various application programs.

In the present embodiment, the utility programs executed by the CPU 111 include a utility program (hereinafter, referred to as a screen switching program) for switching the screen to be operated in accordance with a predetermined operation relative to the touchpad 14 when expansion desktop display is performed. The detail of the screen switching program is explained later.

The CPU 111 executes a Basic Input Output System (BIOS) stored in the BIOS-ROM 116 which is a nonvolatile memory. The BIOS is a system program for hardware control.

The system controller 112 is a bridging device configured to connect the CPU 111 and each component. The system controller 112 includes a built-in serial ATA controller for controlling the HDD 117. Further, the system controller 112 performs communication with each device on a Low Pin Count (LPC) bus.

The GPU 114 is a display controller configured to control the LCD 12A used as a display (monitor) of the electronic apparatus 10. The GPU 114 generates a display signal (LVDS signal) to be supplied to the LCD 12A from display data stored in a video memory (VRAM) 114A.

The GPU 114 is also configured to generate an HDMI video signal and an analogue RGB signal from display data. For example, the HDMI output terminal 20 is configured to transmit an HDMI video signal (uncompressed digital video signal) and a digital audio signal to an external monitor connected by a cable via the HDMI output terminal 20. An analogue RGB signal is supplied to the external monitor via the RGB port 21. This structure realizes expansion desktop display, using the display of the electronic apparatus 10 and the external monitor connected to the electronic apparatus 10.

An HDMI control circuit 130 shown in FIG. 2 is an interface configured to transmit an HDMI video signal and a digital audio signal to an external display via the HDMI output terminal 20.

The sound controller 115 is a sound source device and outputs audio data to be reproduced to, for example, the speakers 16A and 16B.

The Bluetooth module 118 is a module configured to perform wireless communication with a device compatible with Bluetooth by using Bluetooth.

The wireless LAN module 119 is a module configured to perform wireless communication conforming to, for example, the IEEE 802.11 standard.

The SD card controller 120 writes and reads data relative to a memory card inserted into the card slot provided in the electronic apparatus main body 11.

The USB controller 121 performs communication with an external device connected via the USB port 19.

The EC/KBC 122 is connected to an LPC bus. The EC/KBC 122 is interconnected with the PSC 123 and the battery 17 via a serial bus such as an I²C bus.

The EC/KBC 122 is a power management controller configured to manage power of the electronic apparatus 10. For example, the EC/KBC 122 is realized as a single-chip microcomputer including a built-in keyboard controller which controls the keyboard (KB) 13 and the touchpad 14, etc. The EC/KBC 122 has a function for turning the electronic apparatus 10 on and off in accordance with the operation of the power switch 15 by the user. The EC/KBC 122 and the PSC 123 work together to control the turning-on and turning-off of the electronic apparatus 10. When the PSC 123 receives an ON signal transmitted from the EC/KBC 122, the PSC 123 controls the power circuit 124 and turns the electronic apparatus 10 on. When the PSC 123 receives an OFF signal transmitted from the EC/KBC 122, the PSC 123 controls the power circuit 124 and turns the electronic apparatus 10 off.

The power circuit 124 generates power (operating power Vcc) to be supplied to each component by using power supplied from the battery 17 or power supplied from an AC adaptor 140 connected to the electronic apparatus main body 11 as an external power device.

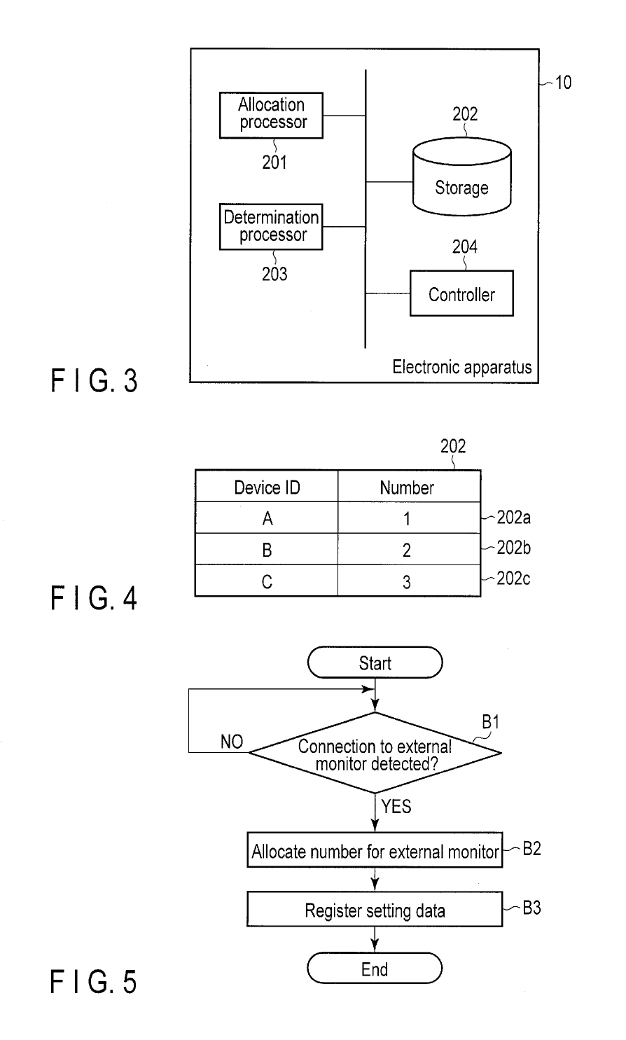

FIG. 3 is a block diagram showing a function structure of the electronic apparatus 10 according to the present embodiment. As shown in FIG. 3, the electronic apparatus 10 includes an allocation processor 201, a storage 202, a determination processor 203 and a controller 204.

In the present embodiment, one of, some of or all of the allocation processor 201, the determination processor 203 and the controller 204 is/are realized when the CPU 111 executes the above-described screen switching program (software). One of, some of or all of the allocation processor 201, the determination processor 203 and the controller 204 may be realized by hardware such as an Integrated Circuit (IC) or may be realized by a structure in which software and hardware are combined. In the present embodiment, the storage 202 is stored in the HDD 117, etc.

Relative to an external monitor which is connected to the electronic apparatus 10 for performing expansion desktop display as described above, the allocation processor 201 performs a process for allocating a number corresponding to the external monitor.

For example, data (hereinafter, referred to as setting data) including the identification data for identifying an external monitor connected to the electronic apparatus 10 (hereinafter, referred to as the device ID) and the number allocated for the external monitor by the allocation processor 201 are stored in the storage 202. When a plurality of external monitors are connected to the electronic apparatus 10, setting data related to each external monitor is stored in the storage 202. Moreover, setting data (that is, setting data related to the electronic apparatus 10) including the device ID for identifying the electronic apparatus 10 and the number allocated for the electronic apparatus 10 (the display of the electronic apparatus 10) are also stored in the storage 202.

Since the touchpad 14 is configured to detect the contact of a user's finger, the touchpad 14 is able to detect an operation (for example, a touch operation or a slide operation) indicating the number allocated for an external monitor connected to the electronic apparatus 10.

The determination processor 203 determines that the screen of the external monitor for which the number indicated by the operation detected by the touchpad 14 is allocated is the screen to be operated based on the setting data stored in the storage 202.

The controller 204 executes a process for switching the screen to be operated from the display screen of the electronic apparatus 10 (hereinafter, referred to as the screen of the electronic apparatus 10) to the screen of the external monitor determined by the determination processor 203. The screen to be operated includes a screen which displays the pointer for performing an operation relative to various objects described above. In this case, for example, the controller 204 controls display of the screen of the electronic apparatus 10 and the screen of the external monitor such that the pointer displayed on the screen of the electronic apparatus 10 moves onto the operation target screen determined by the determination processor 203.

FIG. 4 shows an example of a data structure of the storage 202 shown in FIG. 3. In the example shown in FIG. 4, setting data 202a to 202c are stored in the storage 202.

As shown in FIG. 4, setting data 202a to 202c include device IDs and numbers in an associated manner. The device ID is an identifier for uniquely identifying the electronic apparatus 10 or an external monitor connected to the electronic apparatus 10. For example, the device name or the manufacturing number of the electronic apparatus 10 or the external monitor can be used for the device ID. A number is allocated for (the screen of) the electronic apparatus 10 or the external monitor identified by the associated device ID. The number is, for example, a positive integer.

Setting data 202a includes the device ID “A” and the number “1” in an associated manner. The device ID “A” is an identifier for identifying the electronic apparatus 10. In this case, setting data 202a shows that the number allocated for the electronic apparatus 10 identified by the device ID “A” is one.

Setting data 202b includes the device ID “B” and the number “2” in an associated manner. The device ID “B” is an identifier for identifying an external monitor connected to the electronic apparatus 10. In this case, setting data 202b shows that the number allocated for the external monitor identified by the device ID “B” is two.

Setting data 202c includes the device ID “C” and the number “3” in an associated manner. The device ID “C” is an identifier for identifying an external monitor connected to the electronic apparatus 10. In this case, setting data 202c shows that the number allocated for the external monitor identified by the device ID “C” is three.

FIG. 4 shows an example of a data structure of the storage 202 when two external monitors (identified by the device IDs “B” and “C”) are connected to the electronic apparatus 10 to perform expansion desktop display.

Now, this specification explains the operation of the electronic apparatus 10 according to the present embodiment. In the present embodiment, when an external monitor is connected to the electronic apparatus 10, the electronic apparatus 10 performs a process for allocating a number for the external monitor (hereinafter, referred to as a number allocation process) and a process for switching the screen to be operated in accordance with the operation relative to the touchpad 14 (hereinafter, referred to as a screen switching process). These processes are explained below.

First, this specification explains a procedure of the number allocation process with reference to the flowchart of FIG. 5.

When an external monitor is connected to the electronic apparatus 10 to perform the expansion desktop display mentioned above, for example, the OS operating in the electronic apparatus 10 is configured to detect (recognize) connection of the external monitor.

Thus, the allocation processor 201 determines whether or not connection of an external monitor is detected (block B1).

When the allocation processor 201 determines that connection of an external monitor is not detected (NO in block B1), the processing of block B1 is repeated until connection of an external monitor is detected.

When the allocation processor 201 determines that connection of an external monitor is detected (YES in block B1), the allocation processor 201 allocates a number for the external monitor detected as connected to the electronic apparatus 10 (hereinafter, referred to as an allocation target external monitor) (block B2). In this case, the allocation processor 201 refers to setting data stored in the storage 202 and allocates a number which does not overlap the numbers included in the setting data (specifically, the number allocated for the electronic apparatus 10 and the numbers already allocated for other external monitors) for the allocation target external monitor.

After the processing of block B2, the allocation processor 201 registers (stores), in the storage 202, setting data including the device ID for identifying the allocation target external monitor and the number allocated for the allocation target external monitor (block B3). The device ID for identifying the allocation target external monitor can be obtained from, for example, the allocation target external monitor when the connection of the allocation target external monitor is detected.

As explained above, through the number allocation process, setting data related to an external monitor connected to the electronic apparatus 10 (the number allocated for the external monitor) can be automatically registered (set). The detail of this process is explained with reference to FIG. 4. For example, when the external monitor identified by the device ID “B” is connected to the electronic apparatus 10, setting data 202b is stored in the storage 202 through the number allocation process. Subsequently, for example, when the external monitor identified by the device ID “C” is connected to the electronic apparatus 10, setting data 202c is stored in the storage 202 through the number allocation process. Setting data 202a (that is, setting data related to the electronic apparatus 10) shown in FIG. 4 is stored in the storage 202 in advance at the time of, for example, the default setting of the screen switching program.

In the present embodiment, for example, it is possible to specify the number of screens in expansion desktop display (in other words, the number of screens in the system) based on the number of setting data items stored in the storage 202.

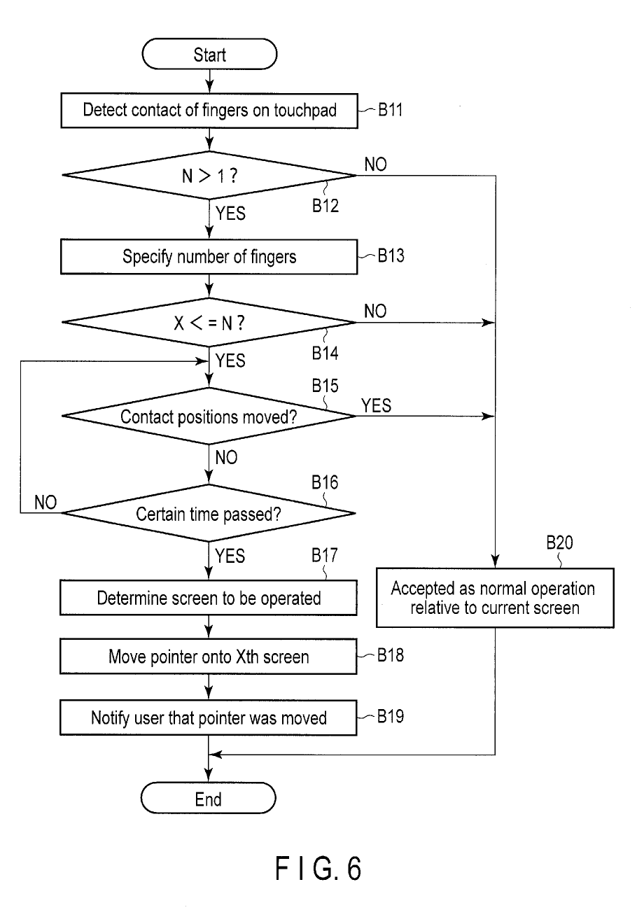

This specification turns to the explanation of a procedure of the screen switching process with reference to the flowchart of FIG. 6.

This specification assumes that expansion desktop display is performed by using the display of the electronic apparatus 10 and at least one external monitor connected to the electronic apparatus 10. Further, this specification assumes that the pointer is displayed on the screen of the electronic apparatus 10.

Now, this specification assumes a case where the pointer displayed on the screen of the electronic apparatus 10 is moved onto the screen of an external monitor (in other words, the screen to be operated is switched from the screen of the electronic apparatus 10 to the screen of the external monitor). In this case, the pointer can be moved onto the screen of the external monitor by repeatedly sliding and moving the pointer (in other words, sliding a finger on the touchpad 14). However, in the present embodiment, the pointer can be immediately moved onto the screen of the external monitor by performing an operation for switching the screen to be operated (hereinafter, referred to as a switching operation) on the touchpad 14.

The switching operation is an operation indicating the number allocated for the external monitor which displays the screen to be operated. The switching operation is set in the electronic apparatus 10 in advance.

In the explanation below, this specification assumes that an operation of maintaining the state in which fingers corresponding to the number allocated for an external monitor come into contact with the touchpad 14 for a certain time is set as the switching operation (the operation indicating the number allocated for an external monitor).

When the user brings his/her fingers into contact with the touchpad 14, the touchpad 14 detects the contact (positions) of the user's fingers (block B11).

When the touchpad 14 detects the contact of the user's fingers, the determination processor 203 determines whether or not the number of screens (N) in expansion desktop display specified based on the number of setting data items stored in the storage 202 is greater than one (block B12). In other words, in block B12, the determination processor 203 determines whether or not one or more external monitors are connected to the electronic apparatus 10. As stated above, each external monitor connected to the electronic apparatus 10 is recognized by the OS. Therefore, the number of screens in expansion desktop display may be specified by inquiry to the OS about it.

When the determination processor 203 determines that N is greater than one (in other words, one or more external monitors are connected to the electronic apparatus 10) (YES in block B12), the determination processor 203 specifies the number of fingers (X) contacting the touchpad 14 based on the contact positions of the user's fingers detected by the touchpad 14 (block B13). For example, when three contact positions are detected by the touchpad 14, the determination processor 203 is able to specify three as the number of fingers contacting the touchpad 14.

Subsequently, the determination processor 203 determines whether or not the specified number of fingers (X) is less than or equal to the number of screens (N) in expansion desktop display (block B14).

When the determination processor 203 determines that X is less than or equal to N (YES in block B14), the determination processor 203 determines whether or not the contact positions of the user's fingers detected by the touchpad 14 moved a predetermined distance or greater (block B15).

When the determination processor 203 determines that the contact positions of the user's fingers did not move a predetermined distance or greater (NO in block B15), the determination processor 203 determines whether or not a predetermined time (a certain time) passed after the detection of the contact of the fingers in block B11 (block B16). In other words, in the processing of block B16, the determination processor 203 determines whether or not the contact of the user's fingers is continuously detected by the touchpad 14 for a certain time.

When the determination processor 203 determines that a certain time passed (YES in block B16), the determination processor 203 recognizes that the operation for indicating the number allocated for an external monitor (that is, a switching operation) is performed by the user. In this case, based on the setting data stored in the storage 202, the determination processor 203 specifies the device ID (specifically, the external monitor identified by the device ID) included in the setting data in association with the number (X) corresponding to the specified number of fingers. The determination processor 203 determines the screen of the specified external monitor as the screen to be operated (the screen onto which the pointer should be moved) (block B17).

When the processing of block 17 is performed, the controller 204 moves the pointer displayed on the screen of the electronic apparatus 10 onto the screen of the external monitor determined by the determination processor 203 (that is, the Xth screen) (block B18).

When the pointer is moved onto the screen of the external monitor in the above manner, the pointer is operated by using the touchpad 14. Thus, the user can perform a normal operation such as an operation of sliding the pointer and specifying (selecting) each object on the screen of the external monitor by sliding a finger on the touchpad 14 and touching the touchpad 14 with a finger.

When the pointer is moved onto the screen of the external monitor determined by the determination processor 203 as described above, the controller 204 notifies the user of moving the pointer (block B19). As an example of the processing in block B19, the controller 204 may blink the screen of the external monitor onto which the pointer was moved. As another example of the processing in block B19, the controller 204 may display the pointer enlarged for a predetermined time after moving the pointer. Other processing may be executed in block B19 as long as the user can easily recognize the screen onto which the pointer was moved.

When the determination processor 203 determines that N is not greater than one (in other words, when the determination processor 203 determines that N is one and no external monitor is connected to the electronic apparatus 10) in block B12 (NO in block B12), the operation of the user relative to the touchpad 14 is accepted as a normal operation (that is, an operation other than a switching operation) relative to the screen which is currently the operation target (here, the display screen of the electronic apparatus 10) (block B20). When the determination processor 203 determines that X is not less than or equal to N in block B14, or when the determination processor 203 determines that the contact positions of the user's fingers moved a predetermined distance or greater in block B15, the processing of block B20 is performed.

When the determination processor 203 determines that a certain time did not pass in block B16 (NO in block B16), the processing returns to and repeats block B15.

In the above-described screen switching process in the present embodiment, when a switching operation for maintaining the state in which the fingers corresponding to the number allocated for an external monitor come into contact with the touchpad 14 for a certain time, it is possible to move the pointer onto the screen of the external monitor and operate the pointer.

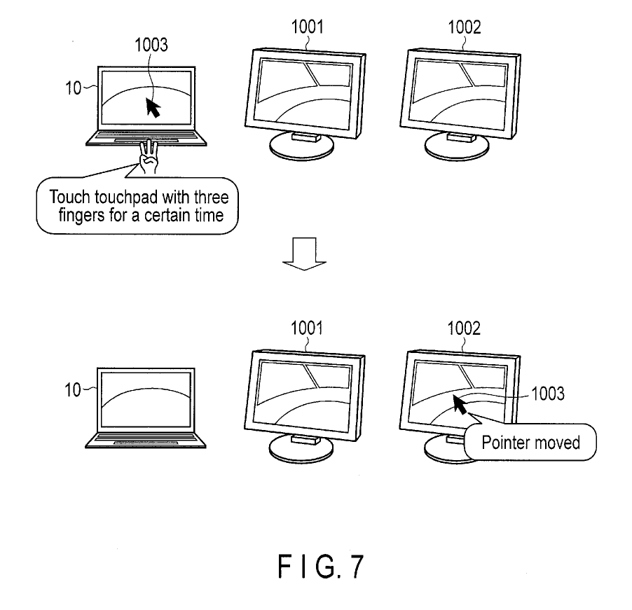

Now, this specification explains the details of the pointer which is moved in the above-described switching operation with reference to FIG. 7.

FIG. 7 assumes that external monitor 1001 and external monitor 1002 are connected to the electronic apparatus 10 in order to perform the expansion desktop display described above. External monitor 1001 is the external monitor identified by the device ID “B” shown in FIG. 4. External monitor 1002 is the external monitor identified by the device ID “C” shown in FIG. 4. The number allocated for external monitor 1001 is two, and the number allocated for external monitor 1002 is three.

This specification assumes that a pointer 1003 is displayed on the display screen of the electronic apparatus 10.

In this case, as shown in FIG. 7, when the user maintains a state in which three fingers come into contact with the touchpad 14 for a certain time, it is possible to move the pointer 1003 onto the screen of external monitor 1002 for which the number “three” is allocated. The pointer 1003 moved onto the screen of external monitor 1002 can be operated by using the touchpad 14.

When the user maintains a state in which two fingers come into contact with the touchpad 14 for a certain time (not shown), it is possible to move the pointer 1003 onto the screen of external monitor 1001 for which the number “two” is allocated.

In FIG. 6 and FIG. 7, this specification mainly explains the case where the pointer 1003 displayed on the display screen of the electronic apparatus 10 is moved onto the screen of an external monitor. However, for example, when the pointer is displayed on the screen of external monitor 1002, and the user maintains a state in which a finger comes into contact with the touchpad 14 for a certain time, it is possible to move the pointer 1003 onto the screen of the electronic apparatus 10 for which the number “one” is allocated. When the pointer is displayed on the screen of external monitor 1002, and the user maintains a state in which three fingers (in other words, the fingers corresponding to the number allocated for the external monitor displaying the screen which is currently the operation target) come into contact with the touchpad 14 for a certain time, the pointer 1003 may be moved onto the screen of the electronic device 10.

When the operation for maintaining a state in which the fingers corresponding to the number allocated for an external monitor come into contact with the touchpad 14 for a certain time is defined as a switching operation as described above, the numbers allocated for the electronic apparatus 10 and the external monitor are preferably selected from one to five in order to allow the user to perform the operation with one hand.

As described above, in the present embodiment, when an operation indicating the number allocated for an external monitor is detected by the touchpad 14, the screen to be operated is switched from, for example, the screen of the electronic apparatus 10 to that of the external monitor. Specifically, the pointer displayed on the screen of the electronic apparatus 10 is moved onto the screen of the external monitor for which the number corresponding to the number of fingers detected by the touchpad 14 is allocated.

In the present embodiment, the above structure enables the user to easily perform an operation relative to the screen of an external monitor (specifically, relative to the objects on the screen) without a complicated operation such as an operation of repeatedly sliding a finger on the touchpad 14 in order to move the pointer onto the screen of the external monitor in expansion desktop display.

In the present embodiment, when the contact of a finger is continuously detected by the touchpad 14 for a predetermined time, and the contact position of the finger does not move a predetermined distance or greater, the pointer is moved onto the screen of an external monitor. In this manner, in the present embodiment, it is possible to clearly distinguish a switching operation for switching the screen to be operated from a normal operation relative to the pointer and objects (for example, an operation of sliding a finger on the touchpad 14 to move the pointer or an operation of touching the touchpad 14 with a finger to specify an object). In other words, in the present embodiment, it is possible to prevent the user from performing a switching operation by mistake. In this manner, the situation in which the pointer is moved onto the screen of an external monitor despite the user's intensions can be avoided.

In the present embodiment, when the pointer was moved onto the screen of an external monitor, the user is notified of moving the pointer onto the screen. This structure allows the user to easily recognize the screen to be operated (that is, the screen which displays the pointer after moving the pointer).

In the above explanation of the present embodiment, the pointer is moved by the switching operation of maintaining a state in which the fingers corresponding to the number allocated for an external monitor come into contact with the touchpad 14 for a certain time. However, the switching operation is not limited to this example.

For example, to move the pointer onto the screen of an external monitor, the user may directly draw the number (figure) allocated for the external monitor, sliding a finger on the touch pad 14.

The pointer may be moved onto the screen of the external monitor for which the number corresponding to the duration of contact of a finger on the touchpad 14 is allocated. Specifically, when the duration of contact of a finger on the touchpad 14 is approximately two seconds, the pointer may be moved onto the screen of the external monitor for which the number “two” is allocated.

A microphone may be activated when the user maintains a state in which a finger comes into contact with the touchpad 14 for a certain time. In this structure, the user inputs voice through the activated microphone. If the analysis result of the voice shows that the user utters “two”, the pointer may be moved onto the screen of the external monitor for which the number “two” is allocated.

In the present embodiment, any operation which indicates the number allocated for an external monitor (or the electronic apparatus 10) (in other words, any operation which can specify the number) may be a switching operation.

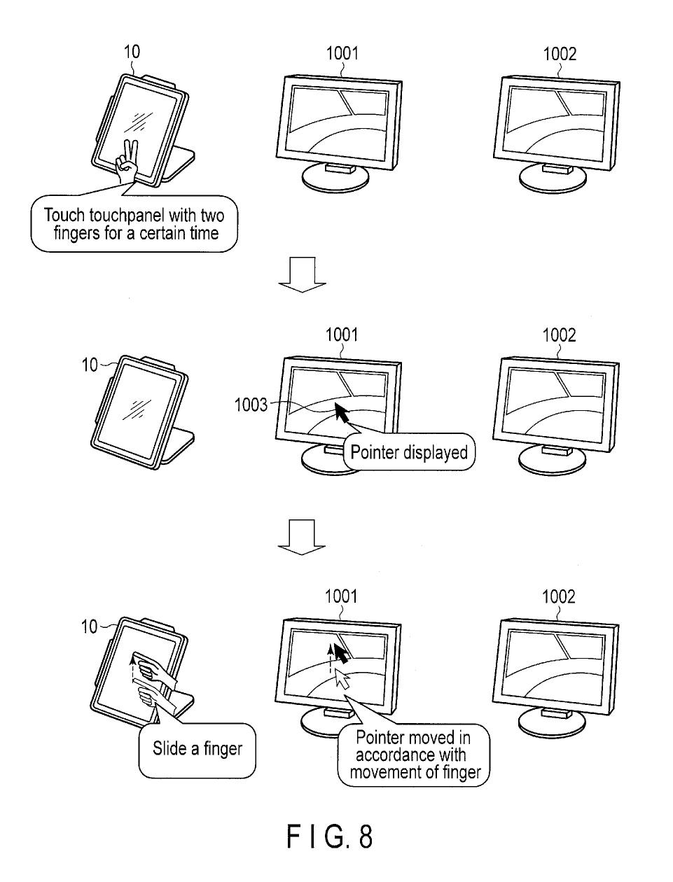

In the above explanation of the present embodiment, the electronic apparatus 10 is a notebook computer including the touchpad 14. However, the electronic apparatus 10 may be realized as a tablet computer including a touchpanel. Specifically, as shown in FIG. 8, when the user maintains a state in which two fingers come into contact with the touchpanel for a certain time, the pointer 1003 may be displayed on the screen of external monitor 1001 for which the number “two” is allocated.

When the pointer 1003 is displayed on the screen of external monitor 1001, for example, the user slides a finger on the display (touchpanel) of the electronic apparatus 10 in order to operate the pointer 1003 on the screen of external monitor 1001.

When the electronic apparatus 10 of the present embodiment is realized as a tablet computer, and a finger continues to come into contact with the tablet computer (touchpanel) for a certain time, a context menu is displayed on the screen of the tablet computer in some cases. Thus, for example, when the screen of external monitor 1001 is the screen to be operated (in other words, when the pointer 1003 is displayed on the screen of external monitor 1001), the screen to be operated may be switched to the screen of the tablet computer by maintaining the state of contact of the fingers (here, two fingers) corresponding to the number allocated for the external monitor for a certain time. A different operation may be set in order to switch the screen to be operated to the screen of the tablet computer.

### Second Embodiment

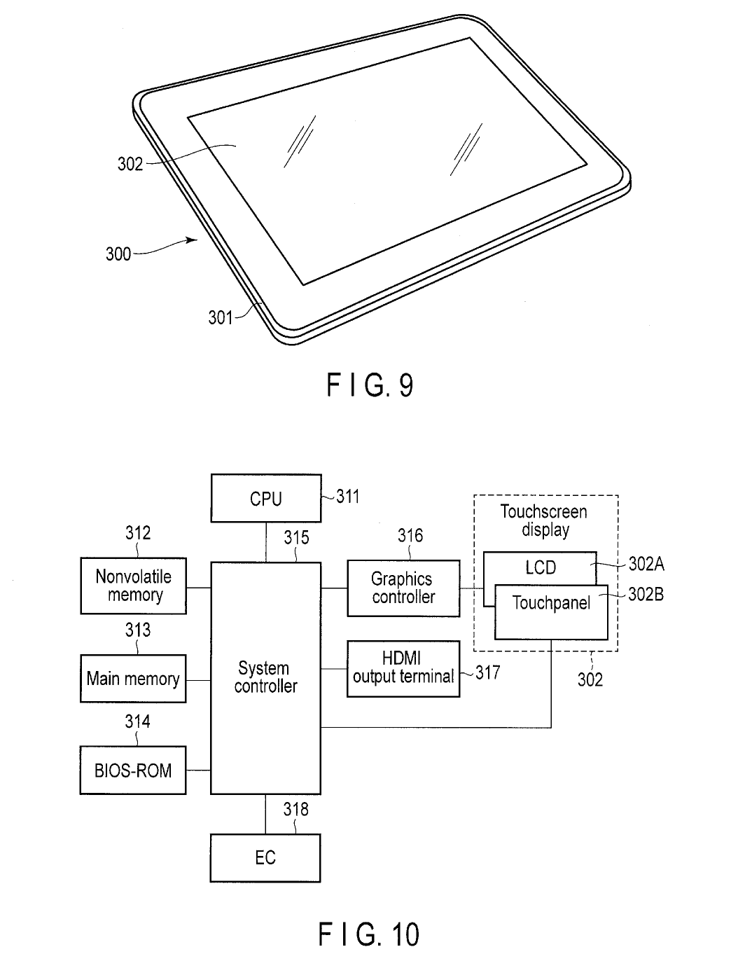

Next, a second embodiment is explained. FIG. 9 is a perspective view showing the external appearance of an electronic apparatus according to the present embodiment. The electronic apparatus can be realized as, for example, a tablet computer or a notebook computer for the user. FIG. 9 shows an example in which the electronic apparatus is realized as a tablet computer. In the explanation below, this specification assumes that the electronic apparatus of the present embodiment is realized as a tablet computer.

As shown in FIG. 9, an electronic apparatus 300 includes an electronic apparatus main body 301 and a touchscreen display 302.

The electronic apparatus main body 301 includes a housing having a thin-box shape. The touchscreen display 302 is attached so as to overlap the upper surface of the electronic apparatus main body 301.

A flat-panel display and a sensor configured to detect the contact position of a finger, etc., on the screen of the flat-panel display are incorporated into the touchscreen display 302. The flat-panel display includes, for example, an LCD. The sensor includes, for example, a touchpanel. In this case, the touchpanel is provided so as to cover the LCD.

The electronic apparatus 300 of the present embodiment is configured to perform expansion desktop display in a manner similar to the electronic apparatus 10 of the first embodiment. In the present embodiment, when an external monitor is connected to the electronic apparatus 300 through, for example, an HDMI output terminal provided in the electronic apparatus 300, the screen can be enlarged by using the display (touchscreen display) of the electronic apparatus 300 and the external monitor. In this case, different screens are displayed on the display of the electronic apparatus 300 and the external monitor. A plurality of external monitors can be connected to the electronic apparatus 300.

FIG. 10 shows a system configuration of the electronic apparatus 300 of FIG. 9. The electronic apparatus 300 includes the touchscreen display 302 described above, a CPU 311, a nonvolatile memory 312, a main memory 313, a BIOS-ROM 314, a system controller 315, a graphics controller 316, an HDMI output terminal 317 and an EC 318, etc. The touchscreen display 302 includes an LCD 302A and a touchpanel 302B.

The CPU 311 is a processor configured to control the operation of each component of the electronic apparatus 300. The processor includes at least one processing circuit. The CPU 311 executes various types of software loaded from the nonvolatile memory 312 which is a storage device into the main memory 313. The software includes an operating system (OS), various utility programs and various application programs.

In the present embodiment, the utility programs executed by the CPU 311 include a utility program (screen switching program) for switching the screen to be operated in response to a predetermined operation relative to the touchpanel 302B when expansion desktop display is performed.

The CPU 311 executes a Basic Input/Output System (BIOS) stored in the BIOS-ROM 314. The BIOS is a program for hardware control.

The system controller 315 is a device configured to connect a local bus of the CPU 311 and various components. The system controller 315 includes a built-in memory controller configured to control the access to the main memory 313. The system controller 315 has a function for communicating with the graphics controller 316 through a serial bus conforming to the PCI EXPRESS standard.

The graphics controller 316 is a display controller configured to control the LCD 302A used as a display monitor of the electronic apparatus 300 (tablet computer). A display signal generated by the graphics controller 316 is sent to the LCD 302A. The LCD 302A displays a screen image based on the display signal. The touchpanel 302B is, for example, a capacitive pointing device allowing the user to input data on the screen of the LCD 302A. For example, the contact position of a user's finger on the screen and movement of the contact position are detected by the touchpanel 302B. By the touchpanel 302B, for example, the graphical user interface displayed on the screen of the LCD 302A can be operated.

For example, the HDMI output terminal 317 is configured to transmit a display signal (HDMI video signal) generated by the graphics controller 316 to an external monitor connected by a cable through the HDMI output terminal 317. In this manner, expansion desktop display is realized by using the display (LCD 302A) of the electronic apparatus 300 and the external monitor connected to the electronic apparatus 300. The HDMI output terminal 317 is provided on a side surface of the electronic apparatus 300 although this structure is omitted in FIG. 9.

The EC 318 is a single-chip microcomputer including an embedded controller for power management. The EC 318 has a function for turning the electronic apparatus 300 on/off in response to the operation by the user relative to a power button (not shown).

Now, this specification mainly explains a function structure of the electronic apparatus 300 according to the present embodiment. For convenience sake, FIG. 3 is used again to explain the structure.

The electronic apparatus 300 of the present embodiment includes an allocation processor 201, a storage 202, a determination processor 203 and a controller 204.

In the present embodiment, a part of or all of the allocation processor 201, the determination processor 203 and the controller 204 can be realized when the CPU 311 executes the above-described screen switching program (software). A part of or all of the allocation processor 201, the determination processor 203 and the controller 204 may be realized by hardware such as an IC or may be realized as a combined structure of software and hardware. In the present embodiment, the storage 202 is stored in the nonvolatile memory 312.

In a manner similar to the first embodiment, the allocation processor 201 allocates a corresponding number for an external monitor connected to the electronic apparatus 300 for expansion desktop display.

For example, setting data including the identification data (device ID) for identifying an external monitor connected to the electronic apparatus 300 and the number allocated for the external monitor by the allocation processor 201 are stored in the storage 202. When a plurality of external monitors are connected to the electronic apparatus 300, setting data related to each external monitor is stored in the storage 202. The setting data stored in the storage 202 is the same as that of the first embodiment explained above. Thus, the detailed explanation of the setting data is omitted.

Since the touchpanel 302B is configured to detect the contact (position) of a user's finger, the touchpanel 302B is configured to detect, for example, an operation (a touch operation or a slide operation, etc.) indicating the number allocated for an external monitor connected to the electronic apparatus 300.

The determination processor 203 determines that the screen of the external monitor for which the number indicated by the operation detected by the touchpanel 302B is allocated is the screen to be operated based on the setting data stored in the storage 202.

The controller 204 switches the screen to be operated from the display screen of the electronic apparatus 300 (hereinafter, referred to as the screen of the electronic apparatus 300) to the screen of the external monitor determined by the determination processor 203. The screen to be operated includes the screen which displays the pointer for performing an operation relative to each object explained above. In this case, the controller 204 displays the pointer (mouse pointer) on the operation target screen (the screen of the external monitor) determined by the determination processor 203.

This specification explains the operation of the electronic apparatus 300 according to the present embodiment. In the electronic apparatus 300 of the present embodiment, in a manner similar to the first embodiment, a number allocation process and a screen switching process are performed. The number allocation process of the present embodiment is the same as the process shown in FIG. 5 explained in the first embodiment. Thus, the detailed explanation of the process is omitted.

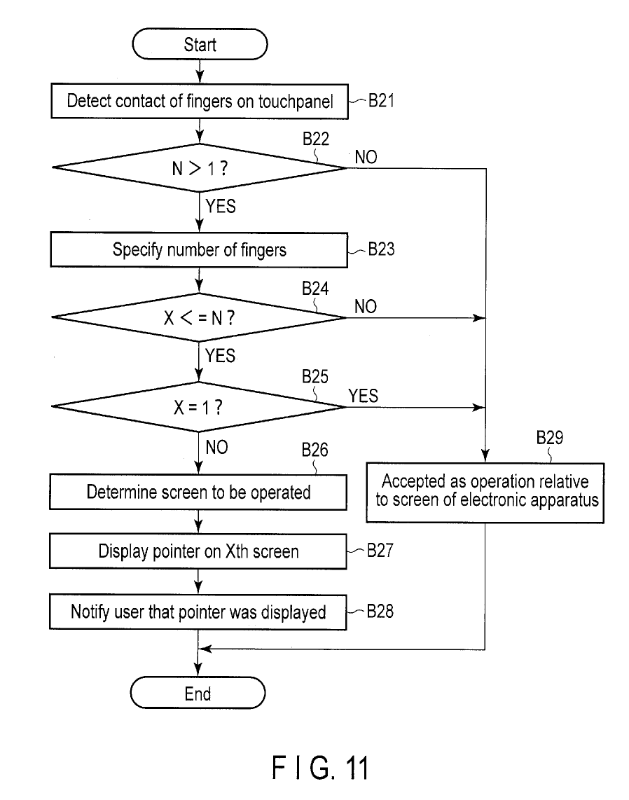

Now, this specification explains a procedure of the screen switching process of the present embodiment, referring to the flowchart of FIG. 11.

Here, this specification assumes that expansion desktop display is performed by using the display (the touchscreen display 302) of the electronic apparatus 300 and at least one external monitor connected to the electronic apparatus 300.

For example, when the electronic apparatus 300 includes the touchpanel 302B, the user can perform an operation (a touch operation or a slide operation) relative to the electronic apparatus 300 by bringing his/her finger into contact with the touchpanel 302B.

On the other hand, unlike the electronic apparatus 10 of the first embodiment (that is, the notebook computer including the touchpad 14), no pointer is displayed on the display of the electronic apparatus 300. Because of this, normally, the user cannot move the pointer onto an external monitor in order to perform an operation relative to various objects. Thus, in an external monitor which does not includes a touchpanel, even when expansion desktop display is performed, the user cannot perform an operation relative to the objects displayed on the screen of the external monitor.

In the present embodiment, when the user performs an operation (switching operation) for switching the screen to be operated on the touchpanel 302B, the pointer is displayed on the screen of an external monitor such that the pointer can be operated on the screen of the external monitor. This structure allows the user to perform an operation relative to various objects on the screen of the external monitor.

This switching operation indicates the number allocated for the external monitor which displays the screen to be operated. The switching operation is set in the electronic apparatus 300 in advance.

In the explanation below, this specification assumes that the operation of bringing the fingers corresponding to the number allocated for an external monitor into contact with the touchpanel 302B is set as the switching operation (the operation indicating the number allocated for the external monitor).

When the user brings his/her fingers into contact with the touchpanel 302B, the touchpanel 302B detects the contact (positions) of the user's fingers (block B21).

When the contact of the user's fingers is detected by the touchpanel 302B, the determination processor 203 determines whether or not the number of screens (N) in expansion desktop display specified based on the number of setting data items stored in the storage 202 is greater than one (block B22). In other words, in the processing of block B22, the determination processor 203 determines whether or not one or more external monitors are connected to the electronic apparatus 300. The number of screens in expansion desktop display may be specified by inquiry to the OS about it.

When the determination processor 203 determines that N is greater than one (in other words, one or more external monitors are connected to the electronic apparatus 300) (YES in block B22), the determination processor 203 specifies the number of fingers (X) contacting the touchpanel 302B based on the contact positions of the user's fingers detected by the touchpanel 302B (block B23). For example, when three contact positions are detected by the touchpanel 302B, the determination processor 203 is configured to specify three as the number of fingers contacting the touchpanel 302B.

Subsequently, the determination processor 203 determines whether or not the specified number of fingers (X) is less than or equal to the number of screens (N) in expansion desktop display (block B24).

When the determination processor 203 determines that X is less than or equal to N (YES in block B24), the determination processor 203 determines whether or not the specified number of fingers (X) is one (that is, X=1) (block B25).

When the determination processor 203 determines that X is not equal to one (NO in block B25), the determination processor 203 recognizes that an operation indicating the number allocated for an external monitor (that is, a switching operation) is performed by the user. In this case, based on the setting data stored in the storage 202, the determination processor 203 specifies the device ID (specifically, the external monitor identified by the device ID) included in the setting data in association with the number (that is, X) corresponding to the specified number of fingers. The determination processor 203 determines the screen of the specified external monitor as the screen to be operated (the screen which displays the pointer) (block B26).

When the processing of block B26 is performed, the controller 204 displays the pointer on the screen of the external monitor determined by the determination processor 203 (that is, the Xth screen) (block B27).

When the pointer is displayed on the screen of the external monitor in this manner, the pointer is operated by using the touchpanel 302B. The user can perform an operation such as an operation of sliding the pointer and specifying (selecting) each object on the screen of the external monitor by sliding the fingers on the touchpanel 302B and touching the touchpanel 302B with the fingers.

In the present embodiment, an operation (a touch operation or a slide operation) with a finger relative to the touchpanel 302B is accepted as an operation relative to the screen of the electronic apparatus 300. Thus, when the pointer displayed on the screen of an external monitor is operated as stated above, the user performs an operation relative to the touchpanel 302B with the fingers corresponding to the number allocated for the external monitor (in other words, the same number of fingers as the number of fingers detected in block B21).

When the pointer is displayed on the screen of the external monitor as described above, the controller 204 notifies the user of the display of the pointer (block B28). The processing of block B28 is the same as that of block B19 shown in FIG. 6 explained above. Thus, the detailed explanation of the step is omitted.

On the other hand, when the determination processor 203 determines that N is not greater than one (in other words, when N is one, and no external monitor is connected to the electronic apparatus 300) in block B22 (NO in block B22), an operation relative to the touchpanel 302B is accepted as an operation relative to the screen of the electronic apparatus 300 (block B29). When the determination processor 203 determines that X is not less than or equal to N in block B24, or when the determination processor 203 determines that X is equal to one in block B25, the processing of block B29 is performed.

In the above-described screen switching process in the present embodiment, when the user performs a switching operation of placing the fingers corresponding to the number allocated for an external monitor in contact with the touchpanel 302B, it is possible to display the pointer on the screen of the external monitor and perform an operation relative to the screen.

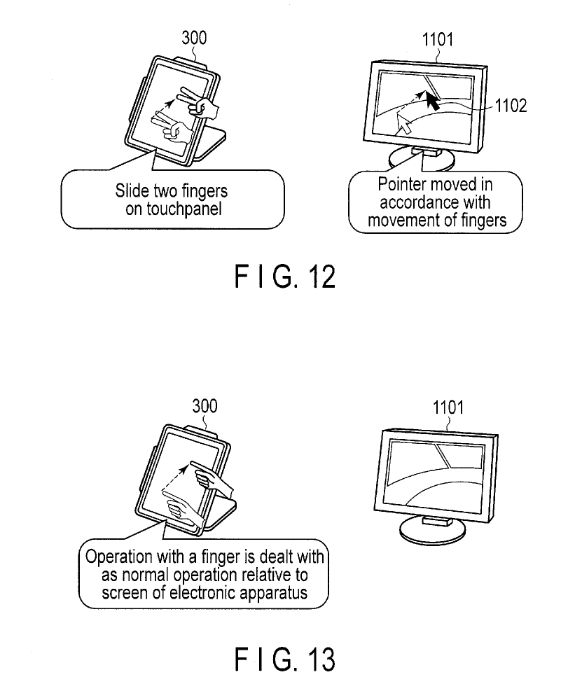

Now, this specification explains the details of the pointer displayed in the above-described switching operation, referring to FIG. 12.

Here, this specification assumes that an external monitor 1101 is connected to the electronic apparatus 300 for performing the above-described expansion desktop display as shown in FIG. 12. The external monitor 1101 is, for example, the external monitor identified by the device ID “B” shown in FIG. 4. The number allocated for the external monitor 1101 is two.

In this case, as shown in FIG. 12, when the user places two fingers in contact with the touchpanel 302B and slides the two fingers on the touchpanel 302B, a pointer 1102 is displayed on the screen of the external monitor 1101 for which the number “two” is allocated, and the pointer can be moved in accordance with the operation (movement of the fingers).

On the other hand, as shown in FIG. 13, when the user performs an operation with a finger relative to the touchpanel 302B, the pointer 1102 is not displayed on the screen of the external monitor 1101. The operation is dealt with as a normal operation relative to the display screen of the electronic apparatus 300.

In the present embodiment, for example, an operation relative to the screen of the external monitor 1101 for which the number “two” is allocated is performed with two fingers. An operation relative to the screen of the electronic apparatus 300 is performed with a finger.

When the external monitor for which the number “three” is allocated (not shown) is connected to the electronic apparatus 300, an operation relative to the screen of the external monitor for which the number “three” is allocated can be performed with three fingers.

In a manner similar to the first embodiment, to enable the user to perform the switching operation with one hand, the number allocated for an external monitor is preferably selected from one to five.

In the present embodiment, as described above, an operation with a finger is dealt with as an operation relative to the screen of the electronic apparatus 300. Thus, setting data related to the electronic apparatus may not be stored in the storage 202.

In the electronic apparatus 300 including the touchpanel 302B, for example, a pinch-in or pinch-out operation may be performed with two fingers. To distinguish this operation from the aforementioned switching operation, the number “two” may not be used for the numbers allocated for external monitors.

As explained above, in the present embodiment, when the touchpanel 302B detects an operation indicating the number allocated for an external monitor, the pointer is displayed on the screen of the external monitor and is operated by using the touchpanel 302B. In the present embodiment, such a structure allows the user to perform an operation relative to various objects displayed on the screen of an external monitor even when the external monitor is connected to the electronic apparatus 300 including the touchpanel 302B for expansion desktop display.

In the above explanation of the present embodiment, the electronic apparatus 300 is a tablet computer including the touchpanel 302B. However, the electronic apparatus 300 may be realized as a notebook computer including a touchpad. Specifically, when the user places two fingers in contact with the touchpad, the pointer may be displayed on (moved onto) the screen of the external monitor 1101 for which the number “two” is allocated.

According to at least one of the embodiments described above, the user can easily perform an operation relative to the screen of an external monitor by switching the screen to be operated from the screen of the electronic apparatus to the screen of the external monitor when an operation indicating the number allocated for the external monitor is detected.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus configured to connect to at least one external monitor and comprising a display and a processing circuit, wherein
the processing circuit is configured to:
detect an operation which indicates a number allocated for the external monitor; and
switch an operative screen from a screen of the display to a screen of the external monitor for which the number indicated by the detected operation is allocated.

2. The electronic apparatus of claim 1, further comprising a touchpad configured to detect contact of at least one finger as the operation which indicates the number allocated for the external monitor, wherein
the processing circuit is further configured to move a pointer displayed on the screen of the display onto the screen of the external monitor for which a number corresponding to the finger detected by the touchpad is allocated.

3. The electronic apparatus of claim 2, wherein
the processing circuit is further configured to move the pointer displayed on the screen of the display onto the screen of the external monitor when the touchpad continuously detects the contact of the finger for a predetermined time.

4. The electronic apparatus of claim 3, wherein
the processing circuit is further configured to move the pointer displayed on the screen of the display onto the screen of the external monitor when a position of the contact of the finger does not move more than a predetermined distance.

5. The electronic apparatus of claim 2, wherein
the processing circuit is further configured to notify a user that the pointer is moved onto the screen of the external monitor when the pointer is moved onto the screen of the external monitor.

6. The electronic apparatus of claim 2, wherein
the processing circuit is further configured to move the pointer onto the screen of the display when the pointer is displayed on the screen of the external monitor and the touchpad detects contact of at least one finger corresponding to a number allocated for the electronic apparatus.

7. The electronic apparatus of claim 1, further comprising a touchpanel covering the display, the touchpanel being configured to detect contact of at least one finger as the operation which indicates the number allocated for the external monitor, wherein
the processing circuit is further configured to display a pointer on the screen of the external monitor for which a number corresponding to the finger detected by the touchpanel is allocated, and
the pointer displayed on the screen is operated by using the touchpanel.

8. A method performed by an electronic apparatus which comprises a display and is connected to at least one external monitor, the method comprising:
detecting an operation which indicates a number allocated for the external monitor; and
switching an operative screen from a screen of the display to a screen of the external monitor for which the number indicated by the detected operation is allocated.

9. A non-transitory computer-readable storage medium having stored thereon a computer program which is executable by a computer which comprises a display and is connected to at least one external monitor, the computer program comprising instructions capable of causing the computer to execute functions of:
detecting an operation which indicates a number allocated for the external monitor; and
switching an operative screen from a screen of the display to a screen of the external monitor for which the number indicated by the detected operation is allocated.
